(19) United States
(12) Patent Application Publication
(10) Pub. No.: US 2010/0162298 A1
(43) Pub. Date: Jun. 24, 2010

(54) METHOD AND APPARATUS FOR RECEIVING BROADCAST DATA

(75) Inventor: Sung-wook AHN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si, (KR)

(21) Appl. No.: 12/573,268

(22) Filed: Oct. 5, 2009

(30) Foreign Application Priority Data
Dec. 22, 2008 (KR) 10-2008-0131206

(51) Int. Cl. H04N 7/025

(52) U.S. Cl. 725/32

(57) ABSTRACT

Disclosed is a method of outputting broadcasting data, the method including outputting advertisement data to be provided in a first channel, when a request to change from the first channel to a second channel is received while the advertisement data is being provided, determining whether or not to change the channel according to information regarding the second channel, and selectively changing channels from the first channel to the second channel according to the decision.

### CROSS-REFERENCE TO RELATED PATENT APPLICATION

This application claims the benefit of Korean Patent Application No. 10-2008-0131206, filed on Dec. 22, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate to outputting data, and more particularly, to a method and apparatus for outputting broadcasting data.

2. Description of the Related Art

Due to recent developments in information/communication technologies, a time period that an individual is exposed to broadcast content has increased. As the time period that an individual is exposed to broadcast content increases, the number of advertisement services, which provide advertisements via a broadcasting reception device to induce viewers to purchase advertised goods or services, also increase. Advertisements provided via a broadcasting reception device are a major source of income for a broadcasting company providing broadcasting services.

### SUMMARY OF THE INVENTION

Exemplary embodiments of the present invention provide a method and an apparatus for outputting broadcasting data in order to provide advertisement effectively.

According to an aspect of the present invention, there is provided a method of outputting broadcasting data, the method including: outputting advertisement data to be provided in a first channel; when a request to change from the first channel to a second channel while the advertisement data is being provided, determining whether or not to change the channel according to information regarding the second channel; and selectively changing channels from the first channel to the second channel according to the decision.

The information regarding the second channel may include at least one of advertisement time information, which indicates a time point for providing an advertisement in the second channel, and data identification information, which indicates a type of advertisement data provided during the advertisement time.

The determination of whether or not to change the channel may include determining whether or not a time point at which the request to change channels is received is during the advertisement time of the second channel, and the selective changing of channels may include, if the time point at which the request to change channels is received is during the advertisement time of the second channel, continuously outputting advertisement data, that is, the advertisement data provided in the first channel.

When the advertisement data is completely output, the first channel may be changed to the second channel.

The selective changing of channels may include, if the time point at which the request to change channels is received is not during the advertisement time of the second channel, changing from the first channel to the second channel.

The continuous outputting of the advertisement data may include reorganizing the advertisement data based on a first time interval, which is a time interval required for completely outputting the advertisement data, and a second time interval, which is a time interval between the time point at which the request to change channels is received and a time point at which the advertisement time of the second channel ends.

The continuous outputting of the advertisement data may include storing broadcasting data to be broadcast in the second channel after the advertisement time of the second channel ends; and outputting the stored broadcasting data when the advertisement data is completely output.

The method may further include receiving additional information from an external source, wherein the additional information includes at least one of advertisement time information indicating time points at which advertisements are provided in at least one channel, advertisement length information indicating time lengths of the advertisements, and data identification information indicating types of advertisements provided in the advertisement times.

The additional information may be an event information table (EIT) defined in open cable application platform (OCAP) standards.

The advertisement data may be either multiplexed with the broadcasting data and transmitted or received from a predetermined storage space.

According to another aspect of the present invention, there is provided a broadcasting data output device including: an output unit for outputting advertisement data provided in a first channel; a determining unit for determining whether to change from the first channel to a second channel based on information regarding the second channel, when a request to change the channel to the second channel is received; a control unit for controlling selective changing of the channel from the first channel to the second channel based on the decision; and a channel changing unit for changing channels from the first channel to the second channel.

### BRIEF DESCRIPTION OF THE DRAWINGS

The above and other features and aspects of the present invention will become more apparent by describing in detail exemplary embodiments thereof with reference to the attached drawings in which:

FIG. 1 is a broadcasting system according to an exemplary embodiment of the present invention;

FIG. 2 is a block diagram of a broadcasting data output device according to an exemplary embodiment of the present invention;

FIG. 3 is a block diagram of a broadcasting data output device according to another exemplary embodiment of the present invention;

FIG. 4 shows an example of additional information regarding a channel, according to an exemplary embodiment of the present invention;

FIG. 5 shows an example of additional information regarding a channel, according to another exemplary embodiment of the present invention;

FIG. 6 is a diagram showing a broadcasting system according to an exemplary embodiment of the present invention;

FIG. 7 is a diagram showing a broadcasting system according to another exemplary embodiment of the present invention;

FIG. 8 is a diagram showing a broadcasting system according to another exemplary embodiment of the present invention;

FIG. 9 is a flowchart of a method of outputting broadcasting data according to an exemplary embodiment of the present invention; and

FIG. 10 is a flowchart of a method of outputting broadcasting data according to another exemplary embodiment of the present invention.

### DETAILED DESCRIPTION OF THE INVENTION

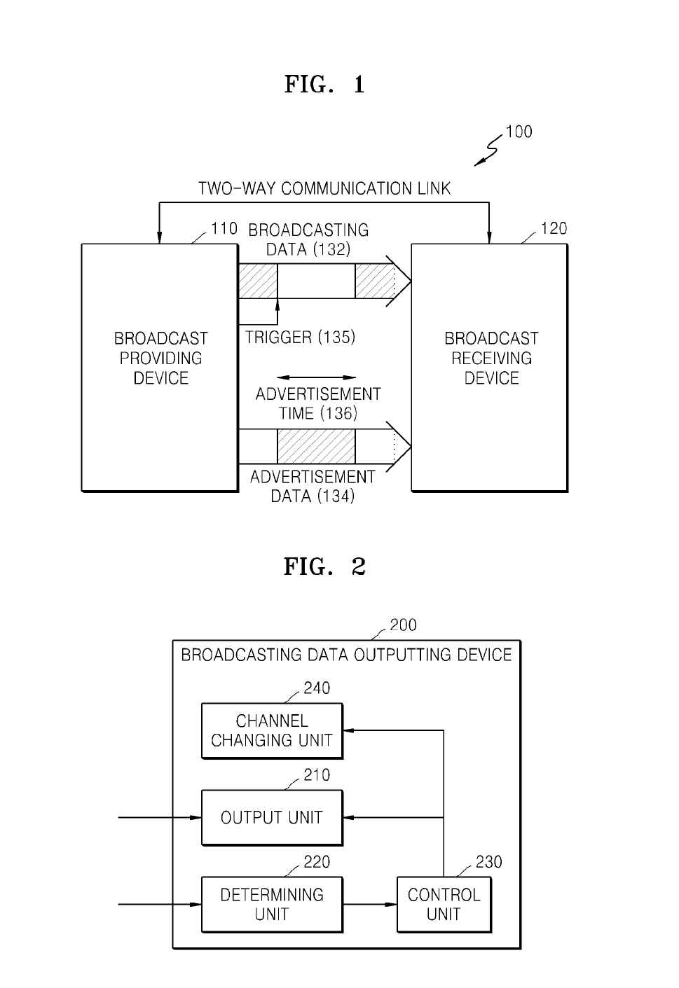

FIG. 1 is a broadcasting system according to an exemplary embodiment of the present invention.

A broadcasting system 100 includes a broadcast providing device 110 and a broadcast receiving device 120. Here, the broadcast providing device 110 may be a server operated by a broadcasting company or an Internet protocol television (IPTV) service provider, whereas the broadcast receiving device 120 may be a TV console, such as a high definition television (HDTV), an IPTV, etc.

Hereinafter, processes for the broadcasting system 100 to provide broadcasting data 132 and advertisement data 134 will be described.

First, when a user turns on the broadcast receiving device 120 and selects a channel to view, the broadcasting system 110 transmits the broadcasting data 132 or the advertisement data 134 to be provided in the selected channel. The broadcast providing device 110 designates parts of time periods for providing a broadcasting service as advertisement times for providing advertisements, and transmits the advertisement data 134 during the advertisement times and transmits the broadcasting data 132 during other time periods.

During advertisement times, the broadcast providing device 110 transmits a trigger 135, which indicates that it is time for the advertisements, to the broadcast receiving device 120. When the trigger 135 is received by the broadcast receiving device 120, the broadcast providing device 110 outputs the corresponding advertisement data 134. At this time, the broadcast providing device 110 transmits physical information regarding the advertisement data 134 to the broadcast receiving device 120, so that the broadcast receiving device 120 can display the advertisement data 134 easily. The physical information may include additional information such as a path for providing the advertisement data 134, the name of the advertisement data 134, etc., and the broadcast receiving device 120 obtains the desired advertisement data 134 according to the physical information and provides the obtained advertisement data 134.

Meanwhile, a user may feel displeasure when an advertisement that is not of interest is displayed, so that the user may change the channel. Changing channel to avoid uninteresting advertisement is known as zapping. The effect of the advertisements is significantly degraded because of zapping. As a method of avoiding such problem, the broadcasting providing device 110 may provide an advertisement service personalized to each user.

The broadcast providing device 110 and the broadcast receiving device 120 may communicate with each other via a two-way communication link. Here, the broadcast providing device 110 may obtain various information regarding preferences of a user, such as frequency of selecting specific channels, viewing time, etc., and may organize and transmit advertisement data which may interest the user. Accordingly, the zapping problem can be partially resolved by providing a personalized advertisement service.

However, there are problems in providing the personalized advertisement service as described below. First, two-way communication between the broadcast providing device 110 and the broadcast receiving device 120 is required for providing an advertisement service personalized to a user, and the requirement causes an increase in prices of the broadcast providing device 110 and the broadcast receiving device 120.

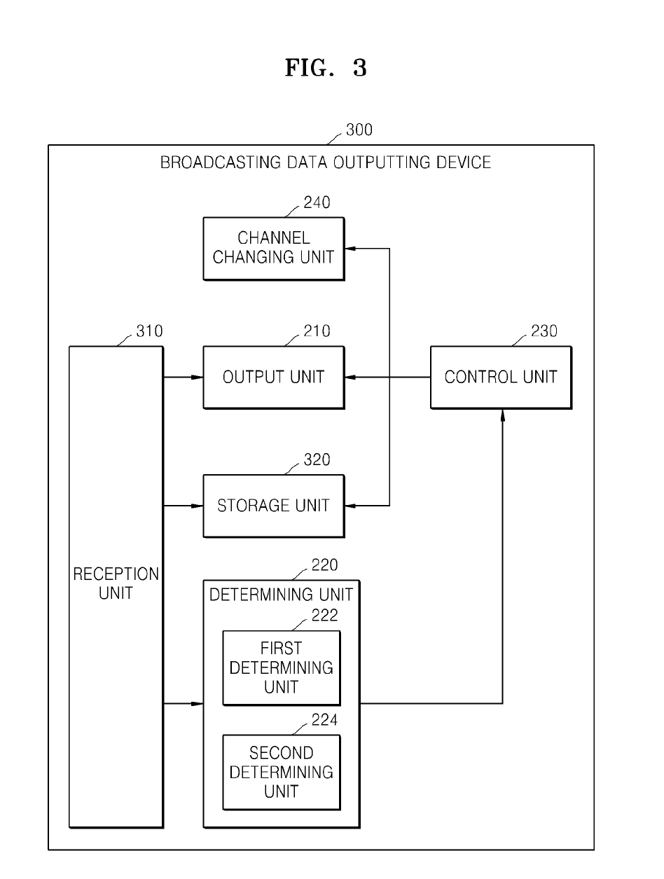

Furthermore, it is impossible to completely resolve the zapping problem by providing the personalized advertisement service. Other methods for resolving the zapping problem will be described below in reference to FIGS. 2 and 3.

FIG. 2 is a block diagram of a broadcasting data output device 200 according to an exemplary embodiment of the present invention.

The broadcasting data output device 200 includes an output unit 210, a determining unit 220, a control unit 230, and a channel changing unit 240.

The output unit 210 outputs advertisement data and broadcasting data. The output unit 210 may output an image to a display device, or an audio to a speaker.

When a user's request to change channel is received while the output unit 210 is outputting advertisement data, the determining unit 220 determines whether or not to change channel based on information regarding a channel to be changed to.

The control unit 230 controls the channel changing unit 240 to selectively perform channel changing based on the decision of the determining unit 220.

The channel changing unit 240 changes channel according to the control of the control unit 230.

Operations of the broadcasting data output device 200 will be described below in chronological order.

First, for convenience of explanation, it is assumed that the output unit 210 is outputting advertisement data provided in a first channel and a user requests to change channel from the first channel to a second channel.

When a user's request to change channel to the second channel is received, the determining unit 220 determines whether or not to change the channel to the second channel based on information regarding the second channel. The information regarding the second channel may include at least one of advertisement time information indicating time points for providing advertisements in the second channel and information indicating types of advertisement provided in the second channel during advertisement times.

Various conditions for not changing channel even if a request to change channel is received may be set up according to the exemplary embodiments. For example, it may be set to not change the channel if a time point at which a request to change channel is received is during an advertisement time of the second channel, because it is meaningless to change channel to the second channel while the second channel is also providing advertisements.

Alternatively, it may be set to not change the channel only if a time point at which a request to change channel is received is during an advertisement time of the second channel and same advertisement data is to be provided in both of the first channel and the second channel. Even if advertisements are also provided in a channel to be changed to, what a user wants by changing the channel may be a different advertisement. Thus, conditions for not changing the channel may be strictly set.

In FIG. 2, it is assumed that the determining unit 220 determines not to change channel in the case where it is during an advertisement time of the second channel when a request to change channel is received. Thus, if it is during the advertisement time of the second channel when the request to change channel is received, the control unit 230 controls the output unit 210 to continuously output advertisement data being provided in the first channel. However, if it is not during the advertisement time of the second channel when the request to change channel is received (e.g. a non-advertisement broadcasting time), the control unit 230 controls the channel changing unit 240 to change the channel to the second channel.

However, even in the former case, if the advertisement data provided in the first channel is completely output, the control unit 230 may control the channel changing unit 240 to change the channel from the first channel to the second channel.

If required, the advertisement time of the second channel may end before the advertisement data provided in the first channel is completely output. At this point, the control unit 230 may control the channel changing unit 240 to change the channel as soon as the advertisement time of the second channel ends. In this case, advertisement data cannot be completely output, and thus the purpose of an advertiser's advertisement cannot be fulfilled. This problem can be resolved by using methods described below.

A first method comprises reorganizing advertisement data provided in the first channel. In other words, a time period required to completely output the advertisement data can be controlled by dividing the advertisement data into a plurality of sections and either selectively outputting sections of high importance or selectively outputting sections preferred by a user.

A second method comprises storing broadcasting data provided in the second channel until advertisement data provided in the first channel is completely output. Thus, after the advertisement data is completely output, broadcasting data provided in the second channel can be output by using the stored data.

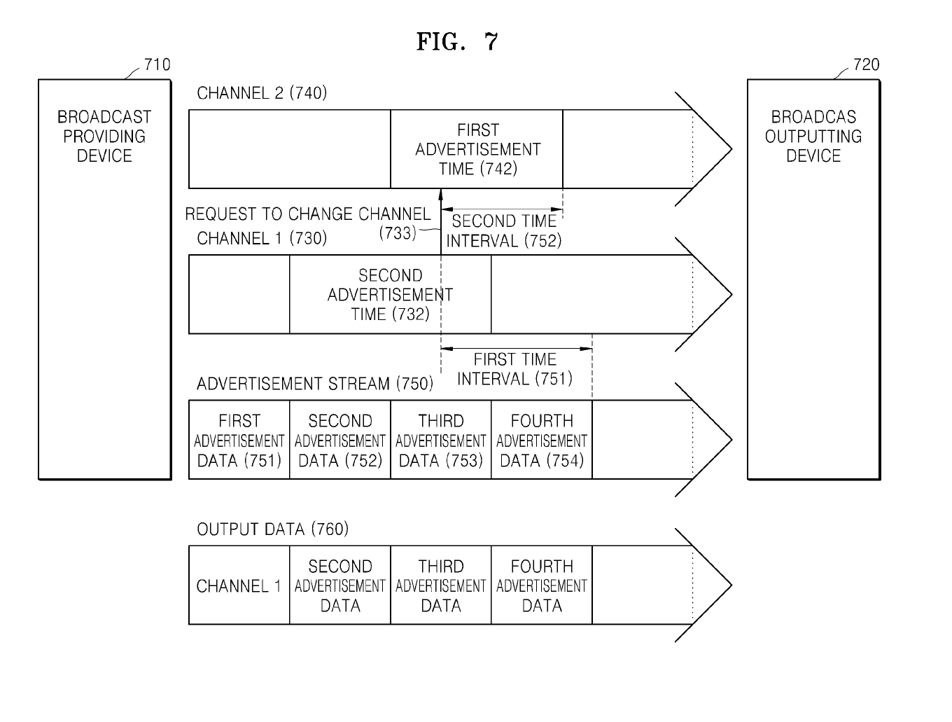

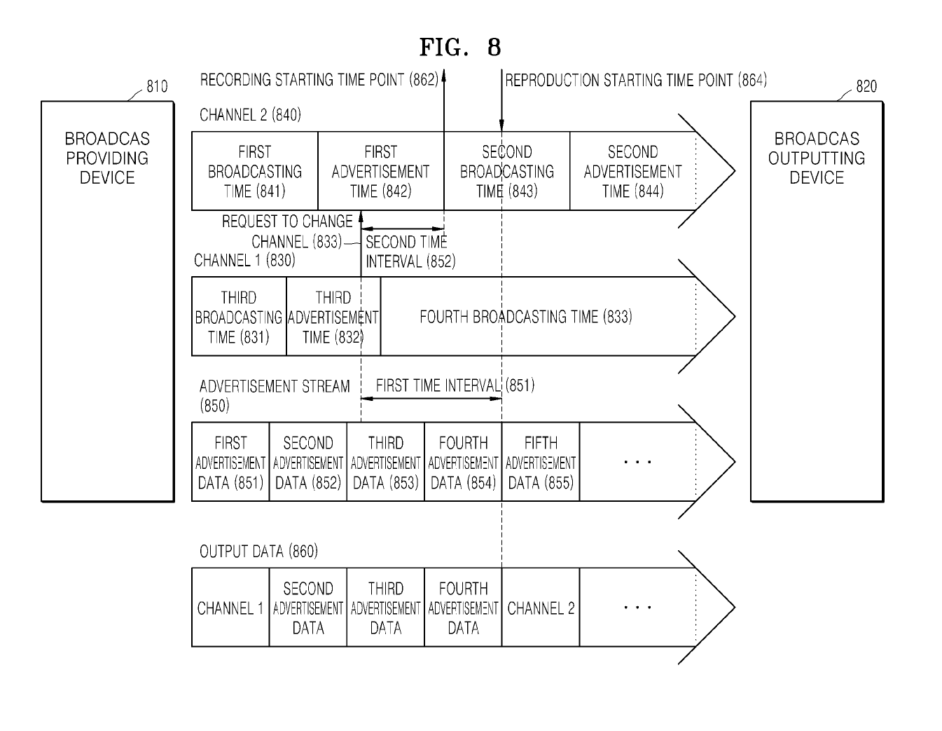

The two methods described above are mere examples of the present invention, and any methods necessary for completely outputting the advertisement data provided in the first channel may be used. The two methods above will be described in detail later in reference to FIGS. 7 and 8.

FIG. 3 is a block diagram of a broadcasting data output device 300 according to another exemplary embodiment of the present invention.

The broadcasting data output device 300 includes the output unit 210, the determining unit 220, the control unit 230, the channel changing unit 240, a reception unit 310, and a storage unit 320. From among the components shown in FIG. 3, components having the same reference numbers as in FIG. 2 perform the same operations as in FIG. 2, and thus detailed descriptions thereof will be omitted below.

The reception unit 310 receives at least one of broadcasting data and advertisement data.

The reception unit 310 may receive advertisement data by various methods. Thus, methods of receiving advertisement data described below are mere examples, and any methods of receiving advertisement data can be used.

First, advertisement data may be multiplexed with broadcasting data, so that the broadcasting data and the advertisement data can be directly received from a same broadcasting system.

Second, advertisement data may be stored in a storage space (e.g. the storage unit 320) within the broadcasting data output device 300 such as a personal video recorder (PVR), and the stored advertisement data may be output when a trigger indicating that it is advertisement time is received.

Third, when a trigger indicating that it is advertisement time is received, advertisement data may be received from a web server. Here, the web server may be operated by the same broadcasting service provider, such as a broadcasting station.

Fourth, advertisement data may be stored in a home server that totally manages contents of terminals within a home network environment, and the stored advertisement data may be output when a trigger indicating that it is advertisement time is received.

Fifth, advertisement data may be inserted using extensible markup language (XML) metadata applied to an IPTV, and the inserted advertisement data may be output.

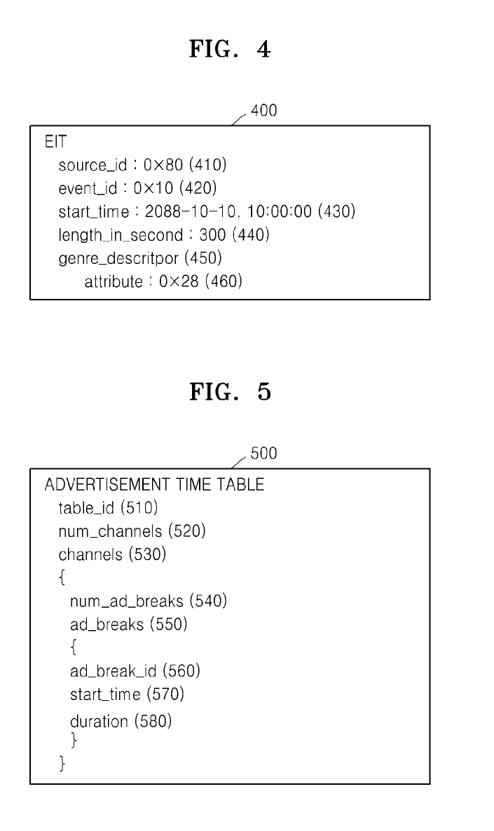

Furthermore, the reception unit 310 can also receive additional information regarding a channel. The additional information may include any information regarding a channel. For example, the additional information may include at least one of advertisement time information indicating time points at which advertisements are provided in at least one channel, advertisement length information indicating time lengths of the advertisements, and data identification information indicating types of advertisements provided in the advertisement times. An example of the additional information will be described in detail below in reference to FIGS. 4 and 5.

The determining unit 220 may include at least one of a first determining unit 222 and a second determining unit 224. The first determining unit 220 determines whether or not a time point at which a request is made to change channel corresponds to an advertisement time of a channel to be changed to. The second determining unit 224 determines whether or not advertisement data provided in the channel to be changed to and advertisement data provided in the current channel are the same.

The control unit 230 controls the channel changing unit 240 to selectively change channels based on the determination of the determining unit 220. At this point, if the playback time of advertisement data provided in the current channel is longer than that of advertisement time provided in the channel to be changed to, the control unit 230 may control either the advertisement data be reorganized or broadcasting data provided in the channel to be changed to be stored in the storage unit 320.

The storage unit 320 stores at least one of advertisement data, broadcasting data, and additional information regarding a channel.

FIG. 4 shows an example of additional information regarding a channel, according to an exemplary embodiment of the present invention.

The additional information shown in FIG. 4 complies with the syntax of the event information table (EIT). The EIT is a table from among tables corresponding to Program and System Information Protocol (PSIP) in U.S. terrestrial wave TV standards, wherein the EIT contains information regarding program events.

In the additional information regarding a channel shown in FIG. 4, a ‘source_id’ field 410 indicates the identifier of the corresponding channel. If the identifier of a first channel is ‘0x80,’ the ‘source_id’ field 410 indicates that the additional information contains information regarding the first channel.

An ‘event_id’ field 420 indicates a type of an event. Although types of events may vary according to the exemplary embodiments, it is assumed below that types of events include a broadcasting time during which broadcasting data is provided and an advertisement time during which advertisement data is provided.

A ‘start_time’ field 430 indicates a time point at which an event corresponding to the ‘event_id’ field 420 occurs. In this regard, FIG. 4 shows that ‘2008 Nov. 10 10:00:00’ is a time point at which an advertisement starts.

A ‘length_in_seconds’ field 440 indicates a duration of a corresponding event. In this regard, FIG. 4 shows that the advertisement time is from ‘2008 Nov. 10 10:00:00’ to ‘2008 Nov. 10 10:05:00.’

A ‘genre_descriptor’ field 450 indicates the genre of data provided during a time for a corresponding event. For example, ‘0x28’ may mean that advertisement data will be provided. Therefore, FIG. 4 shows that advertisement data is continuously provided from ‘2008 Nov. 10 10:00:00’ to ‘2008 Nov. 10 10:05:00.’

FIG. 5 shows an example of additional information regarding a channel, according to another exemplary embodiment of the present invention.

The EIT shown in FIG. 4 either employs a pre-existing data structure as-is or employs a modified version of a pre-existing data structure. However, as shown in FIG. 5, a new data structure may be defined instead of using a pre-existing data structure.

In the additional information regarding a channel shown in FIG. 5, a ‘table_id’ field 510 indicates the type of data. In the current exemplary embodiment, the ‘table_id’ field 510 will have a field value indicating additional information regarding a channel.

A ‘num_channel’ field 520 indicates a number of provided channels.

A ‘channels’ loop 530 indicates information regarding each channel.

A ‘num_ad_breaks’ field 540 indicates the number of advertisement times in each channel.

An ‘ad_breaks’ loop 550 indicates information regarding each advertisement time.

An ‘ad_break_id’ 560 indicates identifiers for identifying each advertisement time.

A ‘start_time’ field 570 indicates a time point at which a corresponding advertisement begins.

A ‘duration’ field 580 indicates the playback time of a corresponding advertisement (difference between the time points at which the corresponding advertisement starts and ends).

The additional information shown in FIGS. 4 and 5 are mere examples, and any types of additional information, including information for identifying channels, information indicating an advertisement time in a corresponding channel (time points at which advertisements start, duration of advertisement, etc.), and information for identifying each advertisement time, may be used.

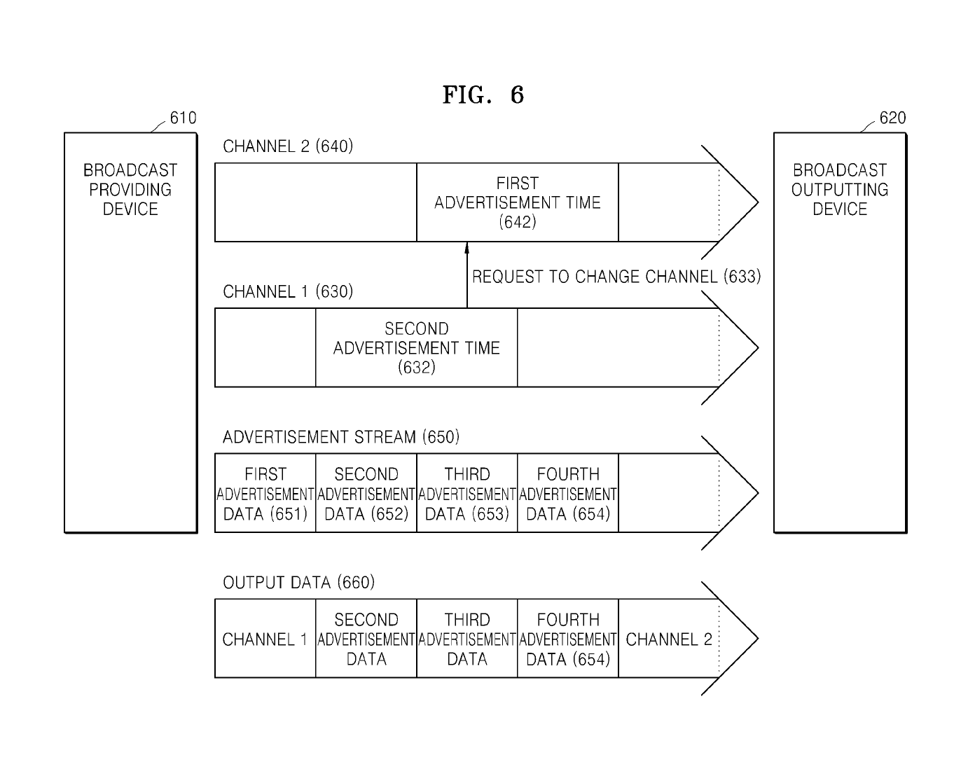

FIG. 6 is a diagram showing a broadcasting system according to an exemplary embodiment of the present invention.

Referring to FIG. 6, a broadcast providing device 610 operates 2 channels, and time periods during which advertisements are output are allocated to each of the two channels.

First, it is assumed that a user is watching a first channel 630. The broadcast outputting device 620 outputs broadcasting data received via a first channel, and, when current time reaches a second advertisement time 632, the broadcast outputting device 620 outputs received advertisement data 652 and a third advertisement data 653 via an advertisement stream 650.

It is assumed that the user requests to change the channel from the first channel 630 to a second channel 640 while the third advertisement data 653 is being output. Since the time point at which the user requested to change channel corresponds to an advertisement time in the second channel, the third advertisement data 653 is continuously output without changing the channel. Furthermore, even after the third advertisement data 653 is completely output, current time corresponds to the advertisement time in the second channel, and thus a fourth advertisement 654 is output successively without channel changing. After the fourth advertisement data 654 is completely output, the channel is changed to the second channel. Therefore, broadcasting data received via the second channel 640 is output after the fourth advertisement data 654 is completely output.

According to the conventional art, the first channel 630 is changed to the second channel 640 as soon as the user requests to change the channel, and thus the user cannot watch the later portion of the third advertisement 653. Thus, the effect of the advertisement significantly decreases. However, in the broadcasting outputting 620 according to an exemplary embodiment of the present invention, the third advertisement data 653 is continuously output without changing the channel if a predetermined condition is satisfied, and thus the effect of the advertisement can be maximized. Especially, a broadcasting system may insert a basic advertisement corresponding to the broadcasting data into broadcasting data and may transmit the broadcasting data into which the basic advertisement is inserted. At this point, the basic advertisement is not an advertisement personalized to the user, and thus the effect of exposing the user to the advertisement is less significant. However, the third advertisement data 653 and the fourth advertisement data 654 that are output by a broadcasting data output device according to an exemplary embodiment of the present invention are advertisements personalized to the user, and thus the effect of the advertisements can be maximized.

Furthermore, in the prior art, a broadcasting data output device goes through steps including: channel 1 630→generating an advertisement insertion trigger→accessing the second advertisement data 652 and the third advertisement data 653 within an advertisement stream 650→requesting to change channel→access a basic advertisement corresponding to the third advertisement data 653 from a channel 2 640→generating an advertisement insertion trigger→access fourth advertisement data within the advertisement stream 650→channel 2 640. Thus, switching operations are performed multiple times.

Meanwhile, in the broadcasting data outputting device 620 according to an exemplary embodiment of the present invention, it is sufficient with steps including: channel 1 630→generating an advertisement insertion trigger→accessing the second advertisement data 652, the third advertisement data 653, and the fourth advertisement data 654 within the advertisement stream 650. Therefore, the number of required switching operations is reduced in the broadcast outputting device 620 according to an exemplary embodiment of the present invention, and thus it is easy to design hardware or software, and sensory broadcasting quality of the user also increases.

FIG. 7 is a diagram showing a broadcasting system according to another exemplary embodiment of the present invention.

In FIG. 7, for convenience of explanation, a time interval required for completely outputting third advertisement data 753 and fourth advertisement data 754 from a time point at which a request 733 to change channels is received is referred to as a first time interval 751, and a time interval between a time point at which the request 733 is received and a first advertisement time 742 is referred to as a second time interval 752.

Referring to FIG. 7, the first time interval 751 is longer than the second time interval 752. Thus, a channel should be changed to a second channel 740 before the fourth advertisement data 754 is completely output. In this case, the user cannot watch the later portion of the fourth advertisement 753, and thus the effect of the advertisement significantly decreases.

A broadcast outputting device 720 according to an exemplary embodiment of the present invention can reorganize the fourth advertisement data 754 such that the fourth advertisement data 754 is completely output within a first advertisement time 742. For example, the broadcast outputting device 720 may divide the fourth advertisement data 754 into a plurality of sections, may exclude less important sections based on the importance of each of the sections, and may output important sections only. According to the exemplary embodiments, the third advertisement data 753 and the fourth advertisement data 754, which are received from the time point at which the request 733 is made, may be all reorganized.

When the fourth advertisement data 754 is reorganized and output as described above, the broadcast outputting device 720 sequentially outputs broadcasting data provided in the channel 1, the second advertisement data, the third advertisement data, and the fourth advertisement data.

FIG. 8 is a diagram showing a broadcasting system according to another exemplary embodiment of the present invention.

As in FIG. 7, a time interval required for completely outputting third advertisement data 853 and fourth advertisement data 854 from a time point at which a request 833 to change channels is received is referred to as a first time interval 851, and a time interval between a time point at which the request 833 is received and a first advertisement time 842 is referred to as a second time interval 852, in FIG. 8.

Referring to FIG. 8, the request 833 is received while the third advertisement data 853 is being output. However, since the first time interval 851 is longer than the second time interval 852, it is impossible to completely output the third advertisement data 853 and the fourth advertisement data 854. Thus, the later portion of the fourth advertisement data is not shown to a user. To resolve such a problem, the broadcast outputting device 820 stores broadcasting data provided during a second advertisement time 843. In other words, the third advertisement data 853 and the fourth advertisement data 854 are continuously output, while broadcasting data received via the channel 2 840 is stored. Then, when the fourth advertisement 654 is completely output, the stored broadcasting data is output to a user

As described above, in the case where the broadcasting data provided in the channel 2 840 is stored, the broadcast outputting device 820 sequentially outputs the broadcasting data in the channel 1→the second advertisement data→the third advertisement data→the fourth advertisement data→the broadcasting data provided in the channel 2.

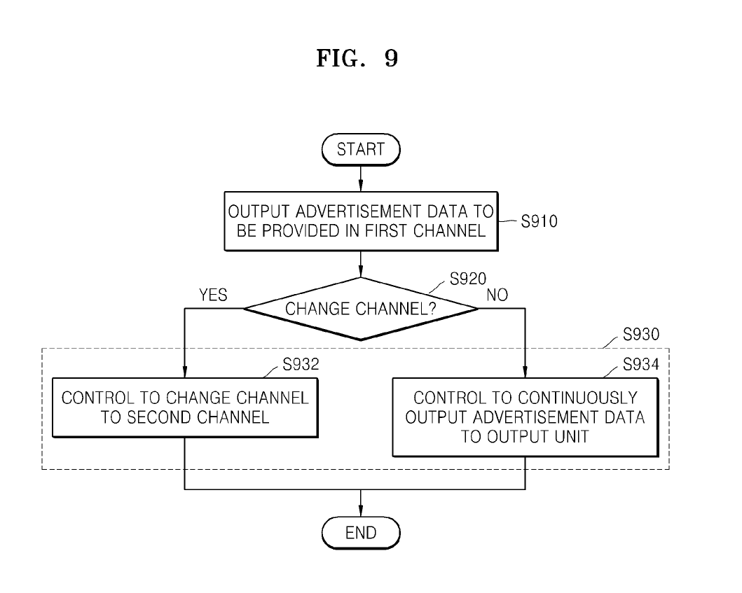

FIG. 9 is a flowchart of a method of outputting broadcasting data according to an exemplary embodiment of the present invention.

In operation S910, advertisement data to be provided in a first channel is output.

In operation S920, when a request to change channels is received, it is determined whether to change from the first channel to a second channel or not based on information regarding the second channel.

In operation S933, the channel is selectively changed from the first channel to the second channel based on the determination of operation S920. More particularly, in case where it is determined to change channels in the operation S920, operation S932 is performed to change from the first channel to the second channel. However, in the case where it is determined to not change channels in operation S920, operation S934 is performed to continuously output advertisement data without changing channels.

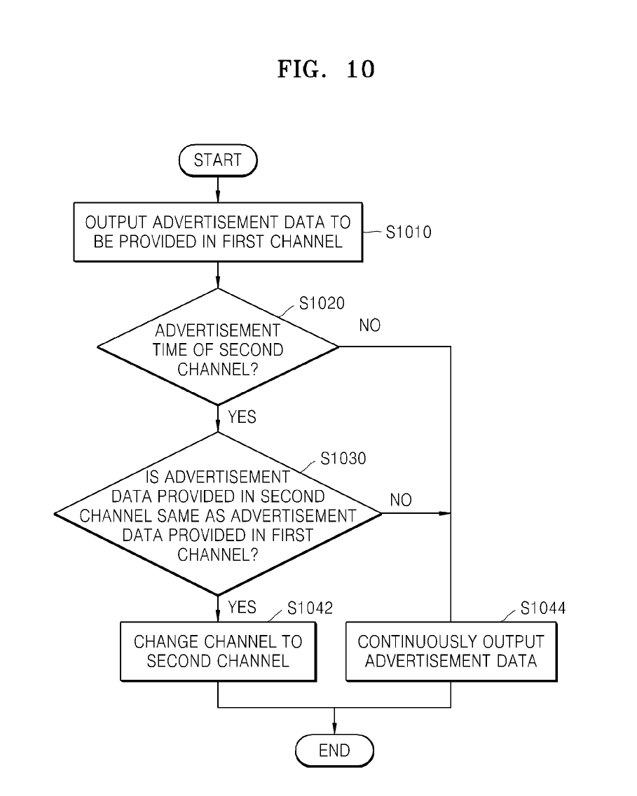

FIG. 10 is a flowchart of a method of outputting broadcasting data according to another exemplary embodiment of the present invention.

In operation S1010, advertisement data provided in a first channel is output.

In operation S1020, when a request to change from the first channel to a second channel is received while the advertisement data is being output, it is determined whether the time point at which the request is received corresponds to an advertisement time in the second channel or not. If the time point at which the request is received does not correspond to an advertisement time in the second channel, operation S 1044 is performed to change from the first channel to the second channel. However, if the time point at which the request is received corresponds to an advertisement time in the second channel, operation S1030 is performed.

In operation S1030, it is determined whether or not advertisement data provided in the second channel and advertisement data provided in the first channel are the same. If the advertisement data provided in the second channel and the advertisement data provided in the first channel are the same, operation S1042 is performed to continuously output the advertisement data provided in the first channel. However, if the advertisement data provided in the second channel and the advertisement data provided in the first channel are not the same, the first channel is changed to the second channel.

The exemplary embodiments of the present invention can be written as computer programs and can be implemented in general-use digital computers that execute the programs using a computer readable recording medium.

Examples of the computer readable recording medium include read-only memory (ROM), random-access memory (RAM), CD-ROMs, magnetic tapes, floppy disks, optical data storage devices, etc.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of outputting broadcasting data, the method comprising:
outputting advertisement data to be provided in a first channel;
when a request to change the first channel to a second channel is received while the advertisement data is being provided in the first channel, determining in a determination, whether or not to change the first channel to the second channel according to information regarding the second channel; and
selectively changing from the first channel to the second channel according to the determination.

2. The method of claim 1, wherein the information regarding the second channel comprises at least one of advertisement time information, which indicates a time point for providing an advertisement in the second channel, and data identification information, which indicates a type of advertisement data provided during an advertisement time of the second channel.

3. The method of claim 2, wherein the determining whether or not to change the first channel to the second channel comprises determining whether or not a time point at which the request to change the first channel to the second channel is received is during the advertisement time of the second channel, and
the selective changing comprises, if the time point at which the request to change the first channel to the second channel is received is during the advertisement time of the second channel, continuously outputting the advertisement data in the first channel.

4. The method of claim 3, wherein, when the advertisement data is completely output, the first channel is changed to the second channel.

5. The method of claim 2, wherein the selective changing comprises, if the time point at which the request to change the first channel to the second channel is received, is not during the advertisement time of the second channel, changing from the first channel to the second channel.

6. The method of claim 3, wherein the continuously outputting of the advertisement data comprises reorganizing the advertisement data based on a first time interval, which is a time interval required for completely outputting the advertisement data, and a second time interval, which is a time interval between the time point at which the request to change the first channel to the second channel is received and a time point at which the advertisement time of the second channel ends.

7. The method of claim 3, wherein the continuously outputting of the advertisement data comprises:
storing broadcasting data to be broadcast in the second channel after the advertisement time of the second channel ends; and
outputting the stored broadcasting data when the advertisement data is completely output.

8. The method of claim 1, further comprising receiving additional information from an external source, wherein the additional information includes at least one of advertisement time information indicating time points at which advertisements are provided in at least one channel, advertisement length information indicating time lengths of advertisements, and data identification information indicating types of advertisements provided in advertisement times.

9. The method of claim 8, wherein the additional information is an Event Information Table (EIT) defined in an Open Cable Application Platform (OCAP) standards.

10. The method of claim 1, wherein the advertisement data is multiplexed with the broadcasting data and transmitted or received from a predetermined storage space.

11. A broadcasting data output device comprising:
an output unit which outputs advertisement data provided in a first channel;
a determining unit which determines in a determination, whether to change the first channel to a second channel based on information regarding the second channel, when a request to change the first channel to the second channel is received;
a control unit which controls selective changing the the first channel to the second channel based on the determination; and
a channel changing unit which changes the first channel to the second channel.

12. The broadcasting data output device of claim 11, wherein the information regarding the second channel comprises at least one of advertisement time information, which indicates a time point for providing an advertisement in the second channel, and data identification information, which indicates a type of advertisement data provided during an advertisement time of the second channel.

13. The broadcasting data output device of claim 12, wherein the determining unit determines whether or not a time point at which the request to change the first channel to the second channel is received is during the advertisement time of the second channel, and
if the time point at which the request to change the first channel to the second channel is received is during the advertisement time of the second channel, the control unit controls the output unit to continuously output the advertisement data.

14. The broadcasting data output device of claim 13, wherein, when the advertisement data is completely output, the control unit further controls the channel changing unit to change the first channel to the second channel.

15. The broadcasting data output device of claim 12, wherein, if the time point at which the request to change the first channel to the second channel is received is not during the advertisement time of the second channel, the control unit further controls the channel changing unit to change the first channel to the second channel.

16. The broadcasting data output device of claim 13, wherein the control unit further comprises a reorganizing unit which reorganizes the advertisement data based on a first time interval, which is a time interval required for completely outputting the advertisement data, and a second time interval, which is a time interval between the time point at which the request of changing the first channel to the second channel is received and a time point at which the advertisement time of the second channel ends.

17. The broadcasting data output device of claim 13, further comprising a storage unit in which data is stored,
wherein the control unit further controls broadcasting data to be broadcast in the second channel after the advertisement time of the second channel ends is stored in the storage unit.

18. The broadcasting data output device of claim 11, further comprising a reception unit which receives additional information from an external source, wherein the additional information includes at least one of advertisement time information indicating time points at which advertisements are provided in at least one channel, advertisement length information indicating time lengths of advertisements, and data identification information indicating types of advertisements provided in advertisement times.

19. The broadcasting data output device of claim 18, wherein the additional information is an Event Information Table (EIT) defined in an Open Cable Application Platform (OCAP) standards.

20. The broadcasting data output device of claim 11, wherein the advertisement data is multiplexed with the broadcasting data and transmitted or received from a predetermined storage space.

21. A computer readable recording medium having recorded thereon a computer program for executing the method of claim 1.
